(19) United States
(12) Patent Application Publication
(10) Pub. No.: US 2020/0034280 A1
(43) Pub. Date: Jan. 30, 2020

(54) EQUIVALENCE VERIFICATION DEVICE AND COMPUTER READABLE MEDIUM

(71) Applicant: MITSUBISHI ELECTRIC CORPORATION, Tokyo (JP)

(72) Inventors: Kazuki YONEMOCHI, Tokyo (JP); Makoto ISODA, Tokyo (JP)

(73) Assignee: MITSUBISHI ELECTRIC CORPORATION, Tokyo (JP)

(21) Appl. No.: 16/489,262

(22) PCT Filed: Apr. 19, 2017
(86) PCT No.: PCT/JP2017/015709

§ 371 Date: Aug. 27, 2019

(51) Int. Cl. G06F 11/36; G06F 8/75

(52) U.S. Cl. CPC G06F 11/3688; G06F 8/71; G06F 8/75; G06F 11/3604

(57) ABSTRACT

A generation unit generates an inspection wrapper for inspecting equivalence of a first function and a second function. The inspection wrapper includes a loop statement for repeatedly calling the first function and the second function. An inspection unit determines equivalence of the first function and the second function for each calling time number where the first function and the second function are called, by conducting equivalence inspection using the inspection wrapper.

### TECHNICAL FIELD

The present invention relates to a technique for inspecting equivalence of functions.

### BACKGROUND ART

Because of the computerization of control functions for realizing multi-functionalization and improvement of additional value, control programs installed in control devices are rapidly becoming larger in scale and more complicated. Furthermore, due to differences in derivative models or destinations, variations of the control programs are expected to increase rapidly in the future.

In order to maintain or enhance profitability in such a situation, it is necessary to work to improve productivity in the development of control programs. As a specific measure, program development may be shifted to differential development or derivative development by introducing execution environments of the program such as communication processing, timer processing, scheduler, operating system (OS), and middleware. In addition, in the operation of differential development and derived development, a program development method and a program development tool for achieving quality assurance of the program and the work efficiency improvement may be applied to program development.

Patent Literature 1 and Patent Literature 2 disclose verification techniques aimed at securing quality of the program.

According to the technique of Patent Literature 1, an input value sequence of a program, an internal state value sequence of the program, an output value sequence of the program, and an inspecting condition describing the requirements of software are described as the constraint conditions of the satisfiability problem. Then, a satisfiability determining tool inspects the program in terms of whether the program violates the constraint condition.

According to the technique of Patent Literature 2, a program is inspected by verifying whether the transition of an internal state value sequence is the same as the defined state transition.

Non-Patent Literature 1 discloses a technique called equivalence inspection.

Equivalence inspection is a technology that determines whether the computation content is logically the same between two programs.

Specifically, under the condition that an input value sequence for the function of one program is equal to an input value sequence for the function of the other program, whether output value sequences of the respective functions match each other is determined using a tool or a model inspection tool. If the output value sequences of the respective functions match each other, it is determined that the functions are equivalent.

Equivalence verification is verification on two programs and not verification on one program.

For example, between one program before transition to a new execution environment and one program after the transition, or between one program before version change and one program after the version change, equivalence verification is conducted to identify an equivalent portion in which the computation content is not logically changed and a different portion in which the computation content is logically changed.

### CITATION LIST

### Patent Literature

Patent Literature 1: JP 2016-57969 A
Patent Literature 2: JP H4-236636 A

### Non-Patent Literature

Non-Patent Literature 1: Rupak Majumdar, “Compositional Equivalence Checking for Models and Code of Control Systems,” 52nd IEEE Conference on Decision and Control, December 2013.

### SUMMARY OF INVENTION

### Technical Problem

In the conventional equivalence inspection, an input value sequence and an output value sequence of each of inspection target functions are exhaustively analyzed as constraint conditions.

However, conventional equivalence verification does not take into account an internal state value sequence that is passed from a previous step to a next step in the function.

For example, in the case of a function that always returns the same output value sequence in response to the same input value sequence, since there is no internal state value sequence, it is possible to correctly inspect the equivalence of the function by the conventional equivalence inspection. However, in the case of a function in which the output value sequence is determined depending on the internal state value sequence that transitions at each step, the equivalence of the functions cannot be inspected correctly by the conventional equivalence inspection due to the presence of the internal state value sequence. A step is a process of calling and executing a function.

An object of the present invention is to make it possible to correctly inspect the equivalence of functions whose output values are determined depending on internal state value sequences that transition at each step.

### Solution to Problem

An equivalence verification device includes an inspection unit that inspects equivalence of a first function and a second function by conducting equivalence inspection using an inspection wrapper being a program code including a loop statement for repeatedly calling the first function and the second function.

### Advantageous Effects of Invention

According to the present invention, equivalence between a first function and a second function can be inspected while repeatedly calling the first function and the second function. Therefore, it possible to correctly inspect the equivalence of functions whose output values are determined depending on internal state value sequences that transition at each step.

### BRIEF DESCRIPTION OF DRAWINGS

FIG. 1 is a configuration diagram of an equivalence verification device 100 in Embodiment 1.

FIG. 2 is a diagram illustrating a first program 210 in Embodiment 1.

FIG. 3 is a diagram illustrating a second program 220 in Embodiment 1.

FIG. 4 is a diagram for explaining steps in Embodiment 1.

FIG. 5 is a diagram illustrating target information 230 in Embodiment 1.

FIG. 6 is a diagram for explaining an input value sequence and an output value sequence in Embodiment 1.

FIG. 7 is a relational diagram of program codes in Embodiment 1.

FIG. 8 is a flowchart of an equivalence verification method in Embodiment 1.

FIG. 9 is a diagram illustrating an inspection header 240 in Embodiment 1.

FIG. 10 is a diagram illustrating an inspection wrapper 250 in Embodiment 1.

FIG. 11 is a flowchart of generation processing (S110) in Embodiment 1.

FIG. 12 is a diagram illustrating the first program 210 in Embodiment 1.

FIG. 13 is a diagram illustrating the second program 220 in Embodiment 1.

FIG. 14 is a flowchart of edit processing (S120) in Embodiment 1.

FIG. 15 is a relational diagram of function names in Embodiment 1.

FIG. 16 is a flowchart of inspection processing (S130) in Embodiment 1.

FIG. 17 is a diagram illustrating an execution result 260 in Embodiment 1.

FIG. 18 is a diagram illustrating an execution result 261 in Embodiment 1.

FIG. 19 is a configuration diagram of an equivalence verification device 100 in Embodiment 2.

FIG. 20 is a diagram illustrating target information 231 in Embodiment 2.

FIG. 21 is a relational diagram of program codes in Embodiment 2.

FIG. 22 is a flowchart of an equivalence verification method in Embodiment 2.

FIG. 23 is a flowchart of analysis processing (S210) in Embodiment 2.

FIG. 24 is a diagram illustrating a first analysis wrapper 270 in Embodiment 2.

FIG. 25 is a diagram illustrating a second analysis wrapper 280 in Embodiment 2.

FIG. 26 is a flowchart of generation processing (S211) in Embodiment 2.

FIG. 27 is a flowchart of edit processing (S212) in Embodiment 2.

FIG. 28 is a diagram illustrating an execution result 262 in Embodiment 2.

FIG. 29 is a flowchart of cyclic number determination processing (S214) in Embodiment 2.

FIG. 30 is a flowchart of inspection step number determination processing (S215) in Embodiment 2.

FIG. 31 is a hardware configuration diagram of an equivalence verification device 100 in the embodiments.

### DESCRIPTION OF EMBODIMENTS

The same elements and equivalent elements are denoted by the same reference numeral throughout the embodiments and drawings. Descriptions on elements denoted by the same reference numeral will be omitted or simplified appropriately. Arrows in the drawings mainly illustrate flows of data or flows of processing.

### Embodiment 1

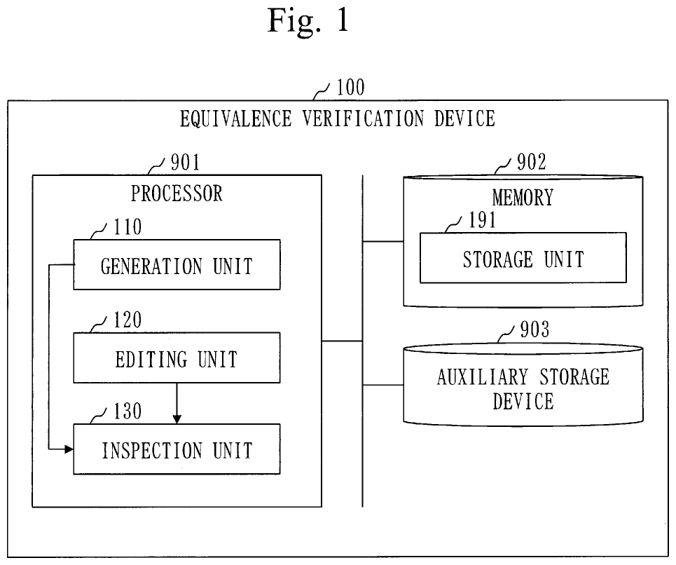

An embodiment of inspecting the equivalence of a first function and a second function will be described referring to FIGS. 1 to 18.

*** Description of Configuration ***

A configuration of an equivalence verification device 100 will be described referring to FIG. 1.

The equivalence verification device 100 is a computer provided with hardware devices such as a processor 901, a memory 902, and an auxiliary storage device 903. These hardware devices are connected to each other via signal lines.

The processor 901 is an integrated circuit (IC) which performs computation processing and controls the other hardware devices. For example, the processor 901 is a central processing unit (CPU), a digital signal processor (DSP), or a graphics processing unit (GPSU).

The memory 902 is a volatile storage device. The memory 902 is also called a main storage device or main memory. For example, the memory 902 is a random access memory (RAM). Data stored in the memory 902 is saved in the auxiliary storage device 903 as necessary.

The auxiliary storage device 903 is a non-volatile storage device. For example, the auxiliary storage device 903 is a read only memory (ROM), a hard disk drive (HDD), or a flash memory. Data stored in the auxiliary storage device 903 is loaded to the memory 902 as necessary.

The equivalence verification device 100 is provided with software elements such as a generation unit 110, an editing unit 120, and an inspection unit 130. A software element is an element that is implemented by software.

An equivalence verification program which causes the computer to serve as the generation unit 110, the editing unit 120, and the inspection unit 130 is stored in the auxiliary storage device 903. The equivalence verification program is loaded to the memory 902 and executed by the processor 901.

Furthermore, an operating system (OS) is stored in the auxiliary storage device 903. The OS is at least partly loaded to the memory 902 and executed by the processor 901.

That is, the processor 901 executes the equivalence verification program while executing the OS.

Data that is obtained by executing the equivalence verification program is stored in a storage device such as the memory 902, the auxiliary storage device 903, a register in the processor 901, and a cache memory in the processor 901.

The memory 902 serves as a storage unit 191 to store data. Another storage device may serve as the storage unit 191 instead of the memory 902 or together with the memory 902.

The equivalence verification device 100 may be provided with a plurality of processors that replace the processor 901. The plurality of processors share the role of the processor 901.

The equivalence verification program can be computer-readably stored in a non-volatile storage medium such as a magnetic disk, an optical disk, and a flash memory. A non-volatile storage medium is a non-transitory tangible medium.

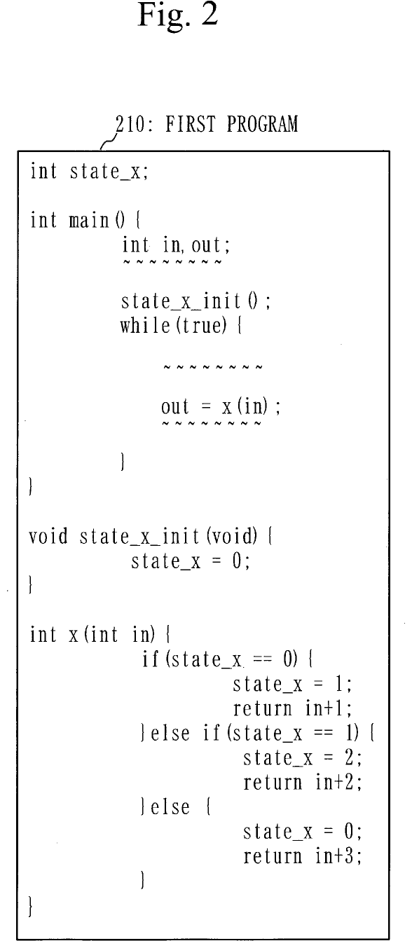

A first program 210 will be described referring to FIG. 2.

The first program 210 is a specific example of a first program and is stored in the storage unit 191 in advance.

The first program is one program out of two programs that are targets of equivalence verification.

The first program 210 is a program code described in the c programming language and includes a first function x.

The first function x is a specific example of a first function.

The first function is one function out of two functions that are targets of equivalence verification.

The first function has features as follows.

The first function is included in the first program. For example, the first function x is included in the first program 210.

The first function is executed a plurality of times in the first program. For example, the first function x is executed repeatedly during a period of time where a specific condition is satisfied in a main function of the first program 210.

The first function uses a first state variable. A value of the first state variable changes each time the first function is executed. For example, the first function x uses a first state variable state_x. A value of the first state variable state_x changes each time the first function x is executed. More specifically, an initial value of the first state variable state_x is 0. If the first function x is executed when the value of the first state variable state_x is 0, the value of the first state variable state_x changes to 1. If the first function x is executed when the value of the first state variable state_x is 1, the value of the first state variable state_x changes to 2. If the first function x is executed when the value of the first state variable state_x is 2, the value of the first state variable state_x changes to 0.

The first function outputs a value corresponding to the first state variable. For example, the first function x outputs a value corresponding to the first state variable state_x. More specifically, when the value of the first state variable state_x is 0, the output value from the first function x is in+1. When the value of the first state variable state_x is 1, the output value from the first function x is in+2. When the value of the first state variable state_x is 2, the output value from the first function x is in+3. Note that “in” of the first function is an input value to the first function x.

The first program 210 has a first initialization function state_x_init.

The first initialization function state_x_init is a specific example of a first initialization function.

The first initialization function is a function that initializes the first state variable. More specifically, the first initialization function state_x_init assigns initial value 0 to the first state variable state_x.

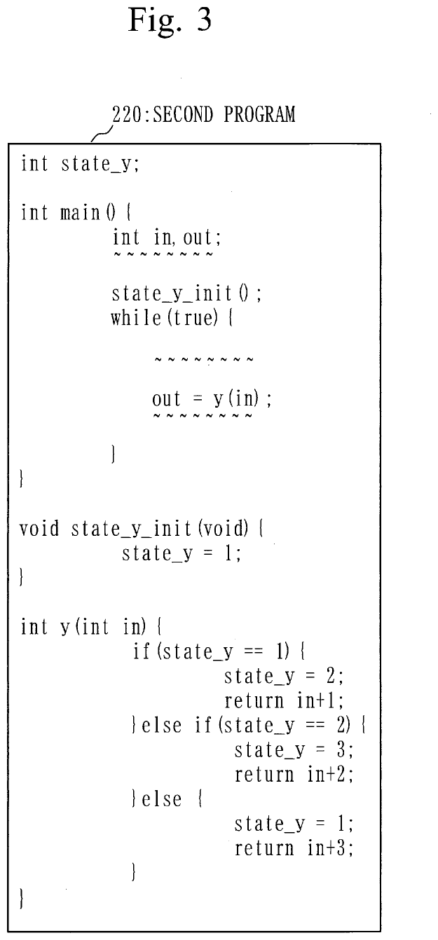

A second program 220 will be described referring to FIG. 3.

The second program 220 is a specific example of a second program and is stored in the storage unit 191 in advance.

The second program is the other program out of the two programs that are the targets of equivalence inspection.

The second program 220 is a program code described in the c programming language and includes a second function y.

The second function y is a specific example of a second function.

The second function is the other function out of the two functions that are the targets of the equivalence inspection.

The second function has features as follows.

The second function is included in the second program. For example, the second function y is included in the second program 220.

The second function is executed a plurality of times in the second program. For example, the second function y is executed repeatedly during a period of time where a specific condition is satisfied in a main function of the second program 220. The second function uses a second state variable. A value of the second state variable changes each time the second function is executed. For example, the second function y uses a second state variable state_y. A value of the second state variable state_y changes each time the second function y is executed. More specifically, an initial value of the second state variable state_y is 1. If the second function y is executed when the value of the second state variable state_y is 1, the value of the second state variable state_y changes to 2. If the second function y is executed when the value of the second state variable state_y is 2, the value of the second state variable state_y changes to 3. If the second function y is executed when the value of the second state variable state_y is 3, the value of the second state variable state_y changes to 1.

The second function outputs a value corresponding to the second state variable. For example, the second function y outputs a value corresponding to the second state variable state_y. More specifically, when the value of the second state variable state_y is 1, the output value from the second function y is in+1. When the value of the second state variable state_y is 2, the output value from the second function y is in+2. When the value of the second state variable state_y is 3, the output value from the second function x is in+3. Note that “in” of the second function is an input value to the second function.

The second program 220 has a second initialization function state_y_init.

The second initialization function state_y_init is a specific example of a second initialization function.

The second initialization function is a function that initializes the second state variable. More specifically, the second initialization function state_y_init assigns initial value 1 to the second state variable state_y.

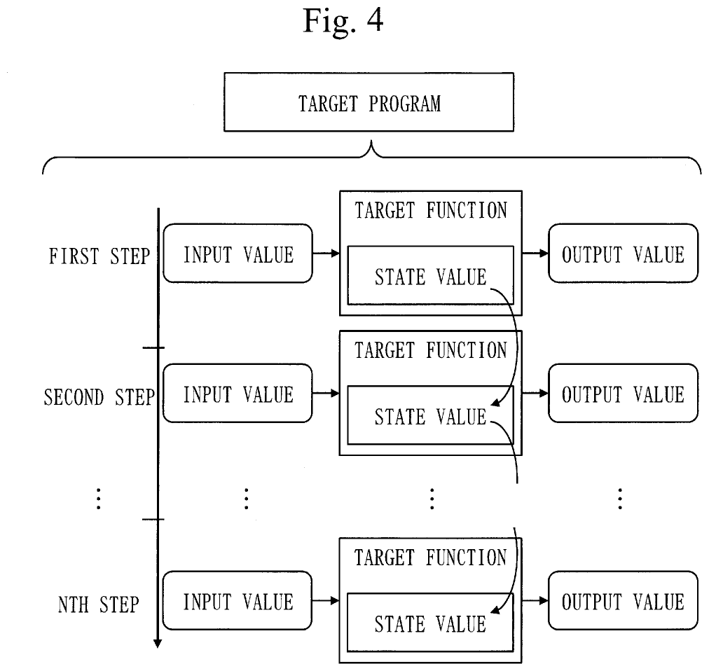

Steps in Embodiment 1 will be described referring to FIG. 4.

Programs that are the targets of equivalence inspection are called target programs. More specifically, the target programs are the first program 210 and the second program 220.

Functions that are the targets of equivalence inspection are called target functions. More specifically, the target functions are the first function x and the second function y.

The values of the state variables are called state values. More specifically, the state values are the value of the first state variable state_x and the value of the second state variable state_y.

A step is a process of calling and executing a target function.

The number of steps is the number of times the target function is called, that is, the number of times the target function is executed.

The state value of the target function is passed between steps. That is, the state value of when the first step is ended is used in the second step, and the state value of when the second step is ended is used in the third step. Input values and output values are not passed between steps.

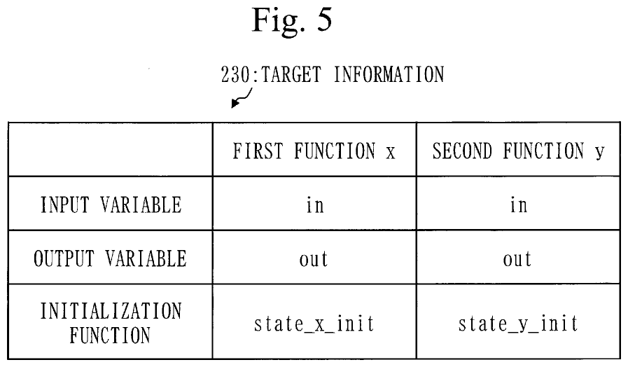

Target information 230 will be described referring to FIG. 5.

The target information 230 is stored in the storage unit 191 in advance.

The target information 230 indicates an input variable, an output variable, and an initialization function of the target function.

The input variable is a variable to which an input value is assigned. An input value is a value inputted to the function.

The output variable is a variable to which an output value is assigned. An output value is a value outputted from the function.

More specifically, the target information 230 indicates a first input variable in, a first output variable out, and the first initialization function state_x_init which are information of the first function x. Also, the target information 230 indicates second input variable in, a second output variable out, and the second initialization function state_y_init which are information of the second function y.

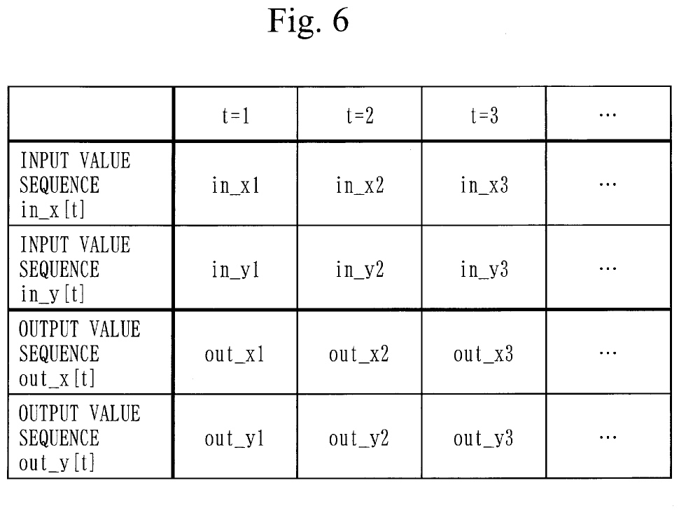

An input value sequence and an output value sequence will be described referring to FIG. 6.

An input value sequence is an input value of the same number as the step number, and is composed of the input value of each step number of the target function. Note that in_x[t] is an input value of the t-th step of the first function x, and that in_y[t] is an input value of the t-th step of the second function y.

An output value sequence is an output value of the same number as the step number, and is composed of the input value of each step number of the target function. Note that out_x[t] is an output value of the t-th step of the first function x, and that out_y[t] is an output value of the t-th step of the second function y.

The input value sequence and the output value sequence are stored in the storage unit 191.

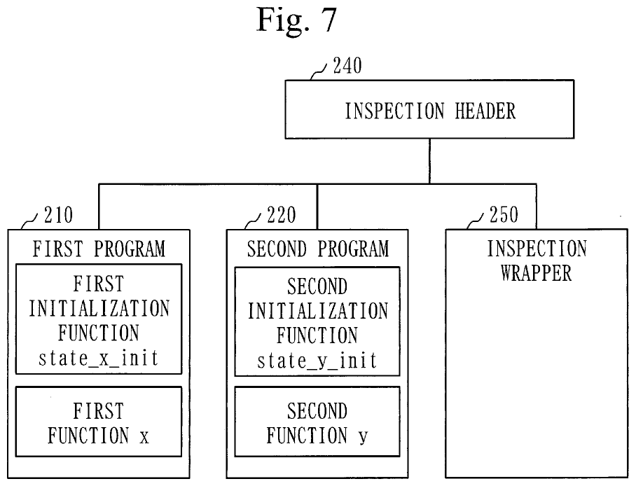

The relation among the first program 210, the second program 220, an inspection header 240, and an inspection wrapper 250 will be described referring to FIG. 7.

The inspection header 240 is a header that is generated for referring to the first function x, the first initialization function state_x_init, the second function y, and the second initialization function state_y_init from the inspection wrapper 250. The inspection header 240 will be described later in detail.

The inspection wrapper 250 is an inspection wrapper that is generated for inspecting the equivalence of the first function x and the second function y. The inspection wrapper 250 will be described later in detail.

The inspection wrapper is a program code that is used for equivalence inspection using a model inspection tool.

The model inspection tool is a conventional tool that conducts equivalence inspection.

In the equivalence inspection, whether a post-event condition is satisfied under a pre-event condition is inspected. If the post-event condition is satisfied under the pre-event condition, the target functions are equivalent.

*** Description of Operation ***

An operation of the equivalence verification device 100 corresponds to an equivalence verification method. A procedure of the equivalence verification method corresponds to a procedure of the equivalence verification program.

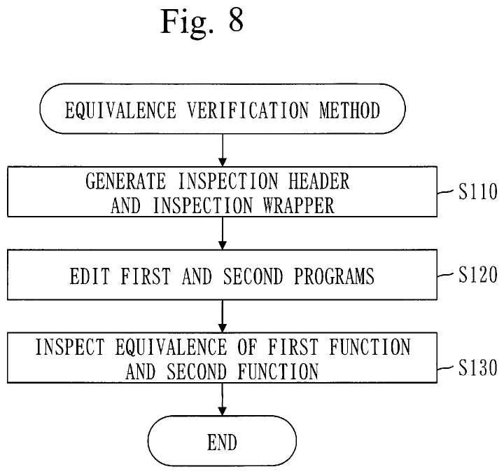

The equivalence verification method will be described referring to FIG. 8.

In step S110, the generation unit 110 generates the inspection header 240 and the inspection wrapper 250.

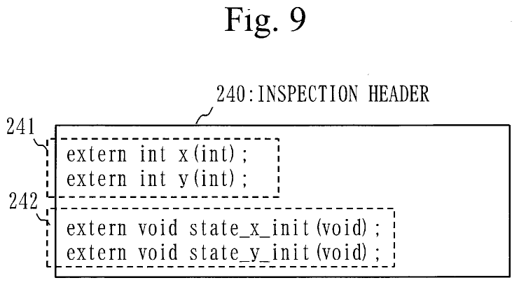

The inspection header 240 will be described referring to FIG. 9.

The inspection header 240 is generated based on the first program 210 of FIG. 2 and the second program 220 of FIG. 3.

The inspection header 240 includes a declaration statement 241 and a declaration statement 242.

The declaration statement 241 is a declaration statement for referring to the first function x and the second function y from the inspection wrapper 250.

The declaration statement 242 is a declaration statement for referring to the first initialization function state_x_init and the second initialization function state_y_init from the inspection wrapper 250.

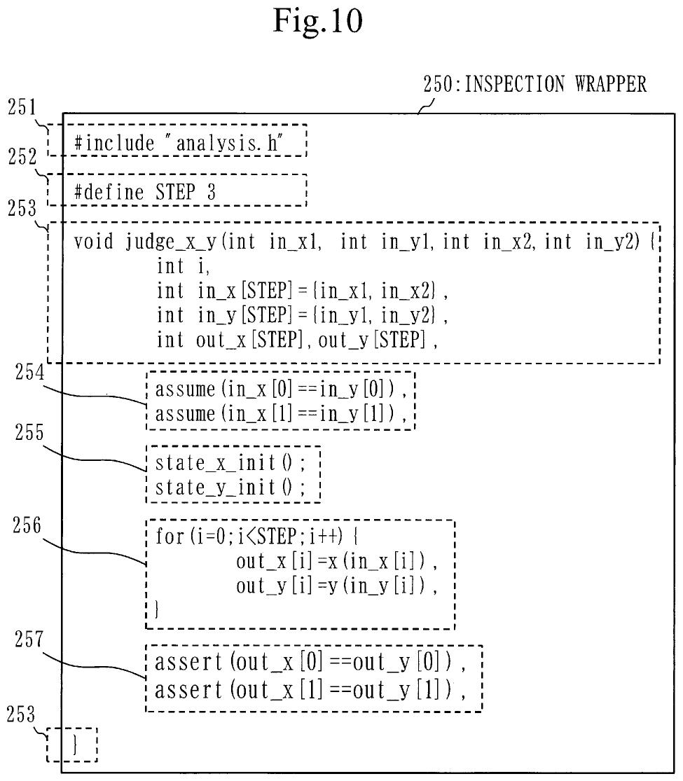

The inspection wrapper 250 will be described referring to FIG. 10.

The inspection wrapper 250 includes an include statement 251, a definition statement 252, a definition portion 253, a pre-event condition statement 254, an initialization statement 255, a loop statement 256, and a post-event condition statement 257.

The include statement 251 is a statement to include the inspection header 240.

The definition statement 252 is a statement to define an inspection step number. An inspection step number is the number of times the first function x and the second function y are called in the loop statement 256.

The definition portion 253 is a definition portion of an inspection function judge_x_y.

The pre-event condition statement 254 is a statement defining a pre-event condition that the input value to the first function x and the input value to the second function y are equal.

The initialization statement 255 is a statement to initialize the first state variable state_x and the second state variable state_y. More specifically, the initialization statement 255 is a statement to call the first initialization function state_x_init and the second initialization function state_y_init. The initialization statement 255 is described as a statement executed prior to the loop statement 256. The loop statement 256 is a statement to call the first function x and the second function y repeatedly.

The post-event condition statement 257 is a statement defining a post-event condition that the output value from the first function x and the output value from the second function y are equal.

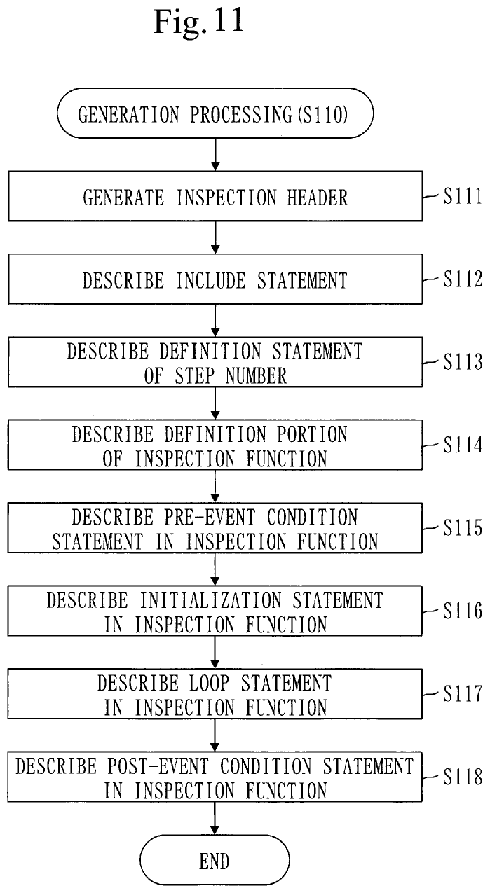

A procedure of generation processing (S110) will be described referring to FIG. 11.

In step S111, the generation unit 110 generates the inspection header 240 (see FIG. 9).

More specifically, the generation unit 110 describes the declaration statement 241 and the declaration statement 242. A file in which the declaration statement 241 and the declaration statement 242 are described is the inspection header 240.

The generation unit 110 describes the declaration statement 241 as follows.

The generation unit 110 extracts a prototype of the first function x from the first program 210 by conducting syntactic analysis of the first program 210, and generates extern declaration of the first function x using the prototype of the first function x.

The generation unit 110 extracts a prototype of the second function y from the second program 220 by conducting syntactic analysis of the second program 220, and generates extern declaration of the second function y using the prototype of the second function y.

Then, the generation unit 110 describes the extern declaration of the first function x and the extern declaration of the second function y.

The extern declaration of the first function x and the extern declaration of the second function y constitute the declaration statement 241.

The generation unit 110 describes the declaration statement 242 as follows. The generation unit 110 extracts a prototype of the first initialization function state_x_init from the first program 210 by conducting syntactic analysis of the first program 210. The generation unit 110 generates an extern declaration of the first initialization function state_x_init using the prototype of the first initialization function state_x_init.

The generation unit 110 extracts a prototype of the second initialization function state_y_init from the second program 220 by conducting syntactic analysis of the second program 220. The generation unit 110 generates an extern declaration of the second initialization function state_y_init using the prototype of the second initialization function state_y_init.

Then, the generation unit 110 describes the extern declaration of the first initialization function state_x_init and the extern declaration of the second initialization function state_y_init.

The extern declaration of the first initialization function state_x_init and the extern declaration of the second initialization function state_y_init constitute the declaration statement 242.

The generation unit 110 generates the inspection wrapper 250 (see FIG. 10) by step S112 to step S118.

In step S112, the generation unit 110 describes the include statement 251 (see FIG. 10).

More specifically, the generation unit 110 generates the include, statement 251 using the file name (analysis.h) of the inspection header 240, and describes the generated include statement 251 to the head of the inspection wrapper 250.

In step S113, the generation unit 110 describes the definition statement 252 (see FIG. 10) of the inspection step number.

More specifically, the generation unit 110 generates the definition statement 252 using a variable name (STEP) of the step variable and the inspection step number (3), and describes the generated definition statement 252 under the include statement 251. The variable name of the step variable and the inspection step number are determined in advance.

In step S114, the generation unit 110 describes the definition portion 253 (see FIG. 10) of the inspection function judge_x_y.

More specifically, the generation unit 110 generates the definition portion 253 as follows and describes the generated definition portion 253 under the definition statement 252.

First, the generation unit 110 describes a prototype of the inspection function judge_x_y. Note that “void judge_x_y( ){ }” is the prototype of the inspection function judge_x_y.

Subsequently, the generation unit 110 generates sets each consisting of an input variable for the first function x and an input variable for the second function y by the same number as the inspection step number, and describes the generated sets of the input variables as arguments of the inspection function judge_x_y. Note that in_x1 and in_x2 are input variables for the first function x, and that in_y1 and in_y2 are input variables for the second function y.

Then, the generation unit 110 generates definition statements that define internal variables used in the inspection function judge_x_y in accordance with the format of a definition statement, and describes the generated definition statements in the inspection function judge_x_y. The formats of the definition statements are determined in advance.

The first definition statement is a statement defining an internal variable i. The internal variable i is a variable used for controlling the loop number in the loop statement 256.

The second definition statement is a statement defining an internal variable in_x[ ]. The internal variable in_x[ ] is an array in which the value of an input variable for the first function x is assigned.

The third definition statement is a statement defining an internal variable in_y[ ]. The internal variable in_y[ ] is an array of an input variable for the second function y.

The fourth definition statement is a statement defining an internal variable out_x[ ] and an internal variable out_y[ ]. The internal variable out_x[ ] is an array in which an output value from the first function x is assigned. The internal variable out_y[ ] is an array in which an output value from the second function y is assigned.

In step S115, the generation unit 110 describes the pre-event condition statement 254 (see FIG. 10) in the inspection function judge_x_y.

More specifically, the generation unit 110 generates pre-event condition statements by the same number as the inspection step number in accordance with the format of a pre-event condition, and describes the generated pre-event condition statements under the four definition statements of the definition portion 253. The generated pre-event condition statements constitute the pre-event condition statement 254. The format of the pre-event condition is determined in advance.

An n-th pre-event condition statement is a statement defining a pre-event condition that an input value to the first function x and an input value to the second function y are equal in the n-th call of the first function x and second function y, where n is an integer of 1 or more and equal to the inspection step number or less.

In step S116, the generation unit 110 describes the initialization statement 255 (see FIG. 10) in the inspection function judge_x_y.

More specifically, the generation unit 110 generates the first initialization statement using the function name of the first initialization function state_x_init, and generates the second initialization statement using the function name of the second initialization function state_y_init. Then, the generation unit 110 describes the first initialization statement and the second initialization statement under the pre-event condition statement 254. The first initialization statement and the second initialization statement constitute the initialization statement 255. The first initialization statement is a statement that calls the first initialization function state_x_init. The second initialization statement is a statement that calls the second initialization function state_y_init.

In step S117, the generation unit 110 describes the loop statement 256 (see FIG. 10) in the inspection function judge_x_y.

More specifically, the generation unit 110 describes a for statement stating a repetition condition that the value of the internal variable i is equal to the inspection step number or less, under the initialization statement 255. Then, the generation unit 110 generates a first call statement and a second call statement in accordance with the format of a call statement, and describes the first call statement and the second statement in the for statement. The format of the call statement is determined in advance.

The first call statement is a statement for calling, in the i-th loop, the first function x taking, as an input value, the value of an internal variable in_x[i] for the first function x, and assigning an output value from the first function x to an internal variable out_x[i] for the first function x.

The second call statement is a statement for calling, in the i-th loop, the second function y taking, as an input value, the value of an internal variable in_y[i] for the second function y, and assigning an output value from the second function y to an internal variable out_x[i] for the second function y.

In step S118, the generation unit 110 describes the post-event condition statement 257 (see FIG. 10) in the inspection function judge_x_y.

More specifically, the generation unit 110 generates post-event condition statements by the same number as the inspection step number in accordance with the format of a post-event condition statement, and describes the generated post-event condition statements under the loop statement 256. The post-event condition statements having the same number as the inspection step number constitute the post-event condition statement 257.

An n-th post-event condition statement is a statement defining a post-event condition that an output value from the first function x and an output value from the second function y are equal in the n-th call of the first function x and second function y, where n is an integer of 1 or more and equal to the inspection step number or less.

Back to FIG. 8, step S120 will be described.

In step S120, the editing unit 120 edits the first program 210 and the second program 220 for the purpose of equivalence inspection.

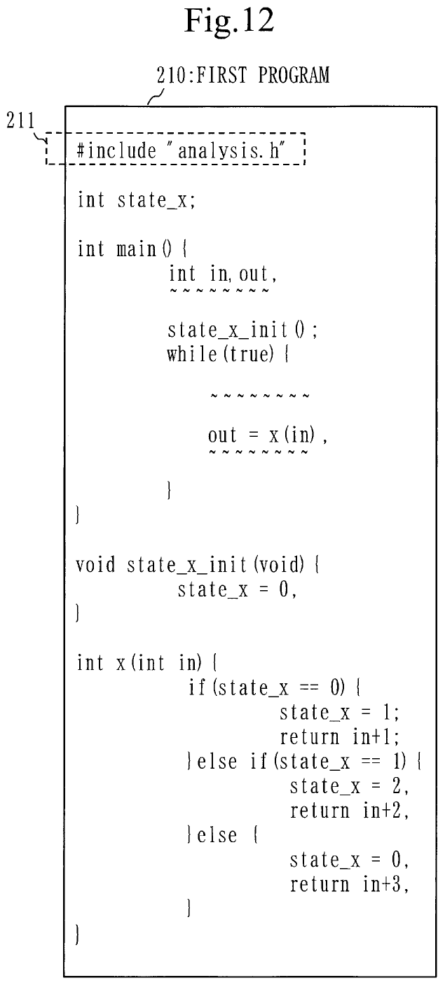

The edited first program 210 will be described referring to FIG. 12.

The edited first program 210 includes an include statement 211.

The include statement 211 is a statement to include the inspection header 240.

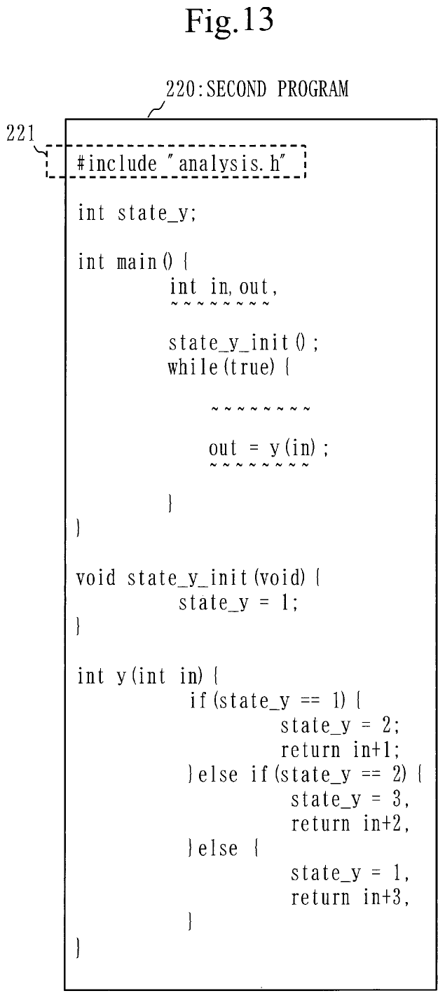

The edited second program 220 will be described referring to FIG. 13.

The edited second program 220 includes an include statement 221.

The include statement 221 is a statement to include the inspection header 240.

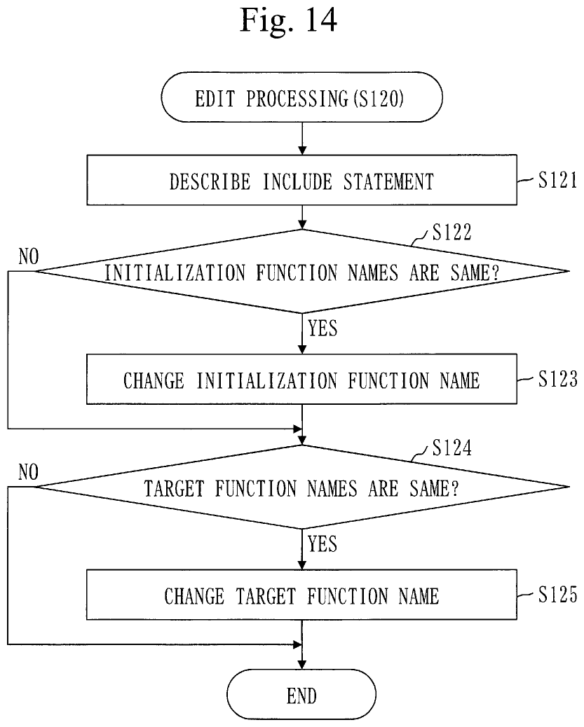

A procedure of edit processing (S120) will be described referring to FIG. 14.

In step S121, the editing unit 120 describes the include statement 211 (see FIG. 12) in the first program 210.

Furthermore, the editing unit 120 describes the include statement 221 (see FIG. 13) in the second program 220.

The include statement 211 and the include statement 221 are the same statement.

More specifically, the editing unit 120 generates the include statement (211, 221) using the file name (analysis.h) of the inspection header 240. Then, the editing unit 120 describes the generated include statement 211 to the head of the first program 210. Furthermore, the editing unit 120 describes the generated include statement 221 to the head of the second program 220.

In step S122, the editing unit 120 determines whether the initialization function name of the first program 210 is the same as the initialization function name of the second program 220. The initialization function name is the name of the initialization function.

If the initialization function name of the first program 210 is the same as the initialization function name of the second program 220, the processing proceeds to step S123.

If the initialization function name of the first program 210 is different from the initialization function name of the second program 220, the processing proceeds to step S124.

In step S123, the editing unit 120 changes at least one of the initialization function name of the first program 210 and the initialization function name of the second program 220.

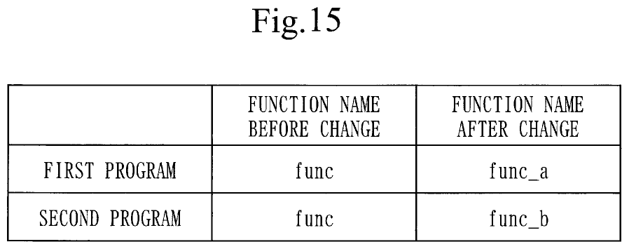

For example, as illustrated in FIG. 15, if both of the initialization function name of the first program 210 and the initialization function name of the second program 220 are “func”, the editing unit 120 adds an identifier to each initialization function name. More specifically, the editing unit 120 changes the initialization function name of the first program 210 from “func” to “func_a”, and changes the initialization function name of the second program 220 from “func” to “func_b”. Note that “_a” and “_b” are the added identifiers.

In step S124, the editing unit 120 determines whether the target function name of the first program 210 is the same as the target function name of the second program 220. The target function name is the name of a function that is the target of equivalence inspection.

If the target function name of the first program 210 is the same as the target function name of the second program 220, the processing proceeds to step S125.

If the target function name of the first program 210 is different from the target function name of the second program 220, the edit processing (S120) ends.

In step S125, the editing unit 120 changes at least one of the target function name of the first program 210 and the target function name of the second program 220.

For example, as illustrated in FIG. 15, if both of the target function name of the first program 210 and the target function name of the second program 220 are “func”, the editing unit 120 adds an identifier to each target function name. More specifically, the editing unit 120 changes the target function name of the first program 210 from “func” to “func_a”, and changes the target function name of the second program 220 from “func” to “func_b”. Note that “_a” and “_b” are the added identifiers.

Back to FIG. 8, step S130 will be described.

In step S130, the inspection unit 130 inspects the equivalence of the first function x and second function y.

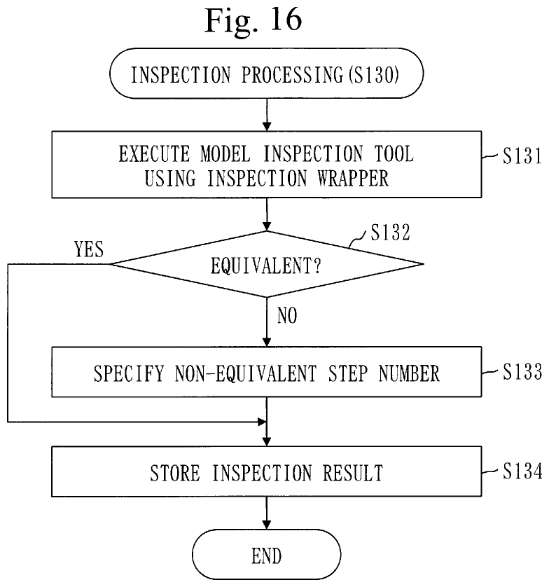

A procedure of inspection processing (S130) will be described referring to FIG. 16.

In inspection processing (S130), the first program 210 signifies the edited first program 210, and the second program 220 signifies the edited second program 220.

In step S131, the inspection unit 130 executes the model inspection tool using the inspection wrapper 250.

Hence, for each calling time number where the first function x and the second function y are called, the equivalence of the first function x and second function y is determined.

The model inspection tool is a conventional tool to conduct equivalence inspection. The model inspection tool is stored in the storage unit 191 in advance. There are a model inspection tool having a conversion function and a model inspection tool not having a conversion function.

A conversion function is a function of converting a target program and an inspection wrapper into an inspection code.

An inspection code is a program code for equivalence inspection.

More specifically, the model inspection tool is executed as follows.

If the model inspection tool has a conversion function, the inspection unit 130, by taking the first program 210, the second program 220, and the inspection wrapper 250 as input, executes the model inspection tool.

When the model inspection tool is executed, the first program 210, the second program 220, and the inspection wrapper 250 are converted into an inspection code, and the inspection code is executed. When the inspection code is executed, an execution result 260 is outputted.

If the model inspection tool does not have a conversion function, the inspection unit 130 converts the first program 210, the second program 220, and the inspection wrapper 250 into an inspection code. This conversion method is the same as the method by the model inspection tool having the conversion function.

Then, the inspection unit 130, by taking the inspection code as input, executes the model inspection tool.

When the model inspection tool is executed, an execution result 260 is outputted.

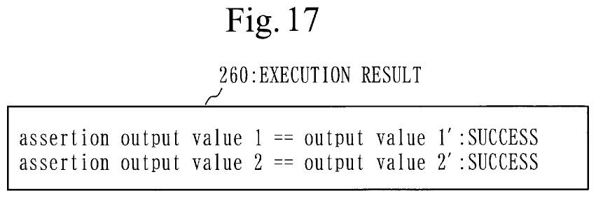

The execution result 260 will be described referring to FIG. 17.

The execution result 260 is a result obtained by executing the model inspection tool using the inspection wrapper 250.

The execution result 260 indicates that the first function x and the second function y are equivalent in each of the first step and the second step.

An output value n signifies an output value from the first function x in the n-th step. An output value n′ signifies an output value from the second function y in the n-th step. SUCCESS signifies that the post-event condition is satisfied. Namely, SUCCESS signifies equivalence.

The n-th step signifies a stage where the first function x and the second function y are called n times where n is an integer of n or more and equal to the inspection step number or less.

Back to FIG. 16, description will continue from step S132.

In step S132, based on the result obtained in step S131, the inspection unit 130 determines whether the first function x and the second function y have been equivalent until the inspection step number.

If the first function x and the second function y have been equivalent until the inspection step number, the processing proceeds to step S134.

If there is an inspection step where the first function x and the second function y are not equivalent, the processing proceeds to step S133.

In step S133, the inspection unit 130 specifies a non-equivalent step number based on the result obtained in step S131.

A non-equivalent step number is a step number of when the first function x and the second function y are non-equivalent, that is, a calling time number of when the first function x and the second function y are non-equivalent. More specifically, the non-equivalent step number is an initial step number of when the first function x and the second function y are non-equivalent.

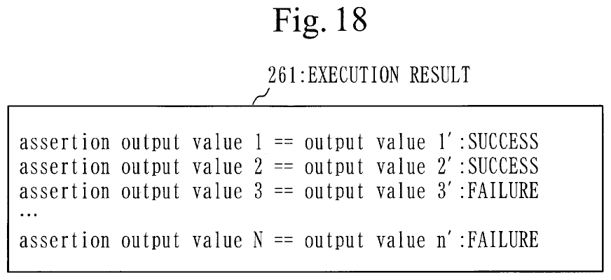

For example, if the result obtained in step S131 is an execution result 261 of FIG. 18, as the determination results of the first step and second step are SUCCESS and the determination result of the third step is FAILURE, the non-equivalent step number is 3. FAILURE signifies that the post-event condition is not satisfied. That is, FAILURE signifies non-equivalence.

In step S134, the inspection unit 130 stores the inspection result to the storage unit 191.

The inspection result indicates whether the first function x and the second function y have been equivalent until the inspection step number.

If the first function x and the second function y have been non-equivalent until the inspection step number, the inspection result further indicates a non-equivalent step number.

### Effect of Embodiment 1

It is possible to realize equivalence inspection of functions each of which possesses a state value that is maintained from one step to the next step. More specifically, a determination result indicating equivalence or non-equivalence can be obtained at a preset stage number.

*** Other Configurations ***

The target program, the target function, the inspection wrapper, and the inspection header may be described using a programming language other than the c programming language. If, without an inspection header, a target function can be called from an inspection wrapper, then the inspection header is unnecessary.

### Embodiment 2

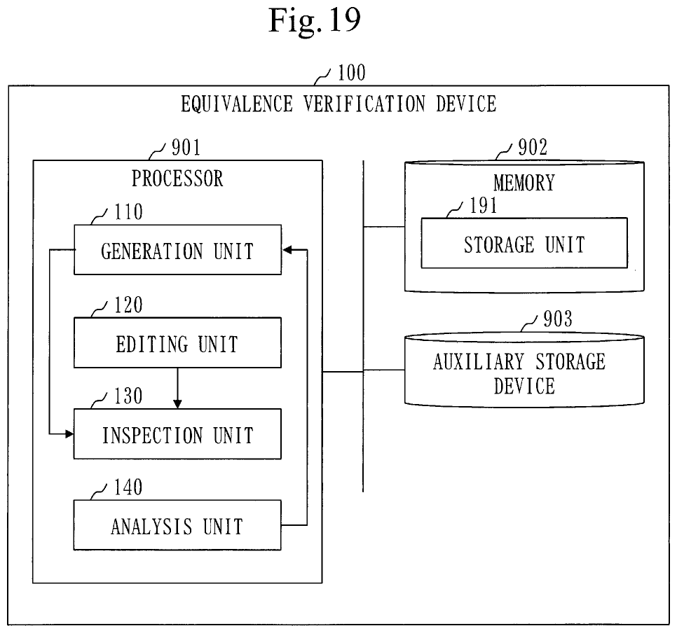

An embodiment of determining an inspection step number will be described mainly regarding its difference from Embodiment 1 referring to FIGS. 19 to 30.

*** Description of Configuration *** A configuration of an equivalence verification device 100 will be described referring to FIG. 19.

The equivalence verification device 100 is further provided with an analysis unit 140 as a software element.

An equivalence verification program causes a computer to further function as the analysis unit 140.

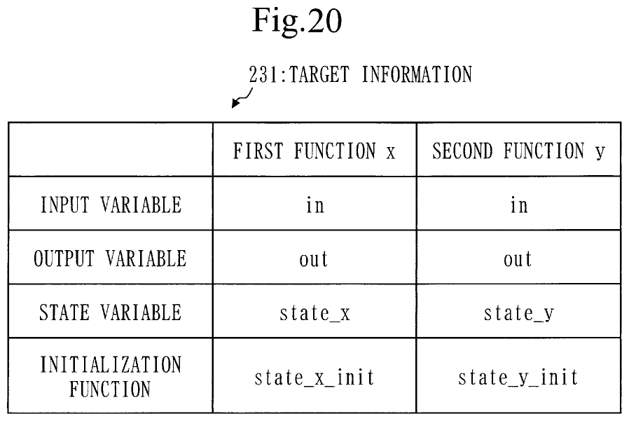

Target information 231 will be described referring to FIG. 20.

The target information 231 is an example of target information. The target information 231 is stored in a storage unit 191 in advance.

The target information 231 indicates a state variable in addition to an input variable, an output variable, and an initialization function.

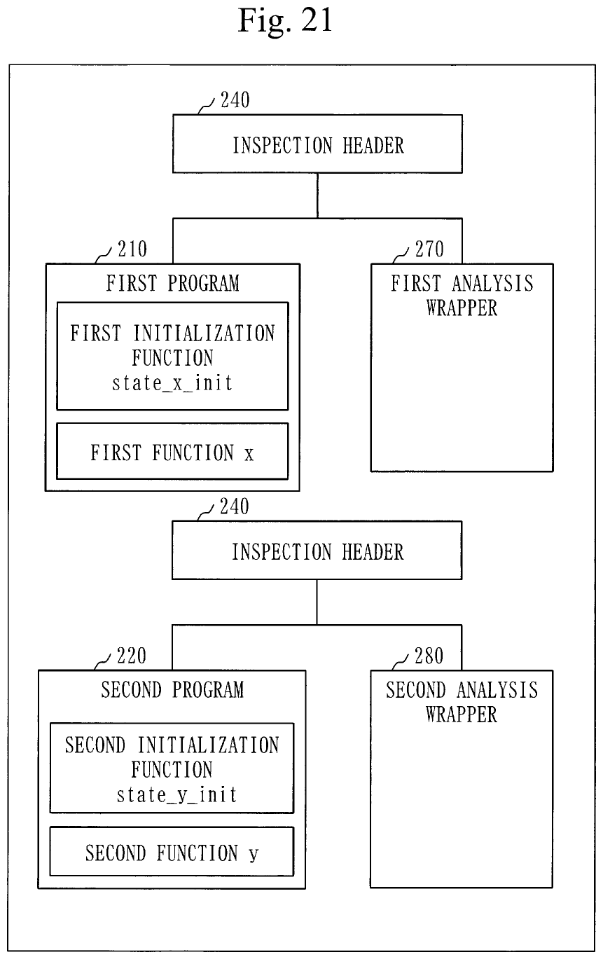

A relation among a first program 210, an inspection header 240, and a first analysis wrapper 270 will be described referring to FIG. 21.

The inspection header 240 is included in each of the first program 210 and the first analysis wrapper 270.

The first analysis wrapper 270 is an inspection wrapper that is used in equivalence verification aimed at obtaining a first cyclic number.

The first cyclic number is a calling time number of when a value of a first state variable returns to an initial value.

The first analysis wrapper 270 will be described later in detail.

A relation among the second program 220, the inspection header 240, and a second analysis wrapper 280 will be described referring to FIG. 21.

The inspection header 240 is included in each of the second program 220 and the second analysis wrapper 280.

The second analysis wrapper 280 is an inspection wrapper that is used in equivalence inspection aimed at obtaining a second cyclic number.

The second cyclic number is a calling time number of when a value of a second state variable returns to an initial value.

The second analysis wrapper 280 will be described later in detail.

*** Description of Operation ***

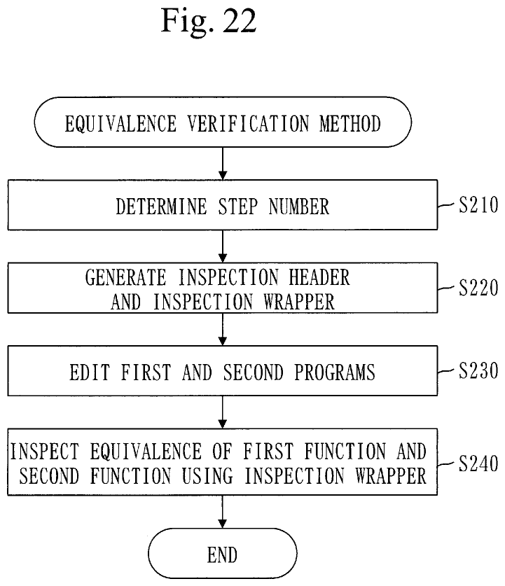

An equivalence verification method will be described referring to FIG. 22. In step S210, the analysis unit 140 determines an inspection step number defined in an inspection wrapper 250. How to determine the inspection step number will be descried later.

Step S220 to step S240 are the same as step S110 to step S130 in Embodiment 1 (see FIG. 8).

Note that in step S220, the generation unit 110 describes a statement defining the inspection step number determined in step S210, in the inspection wrapper 250 as a definition statement 252.

If it is determined in step S240 that the first function and the second function are equivalent, the first function and the second function are completely equivalent. Completely equivalent signifies that the functions are equivalent whatever the step number may be.

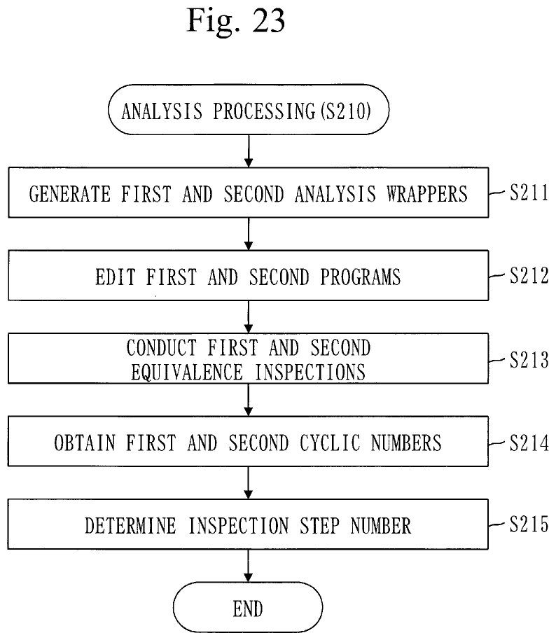

A procedure of analysis processing (S210) will be described referring to FIG. 23.

In step S211, the generation unit 110 generates the first analysis wrapper 270 and the second analysis wrapper 280.

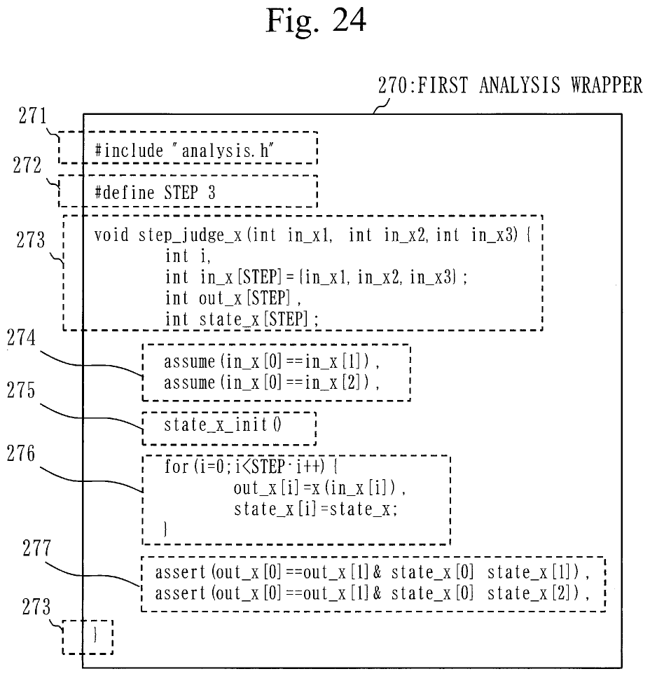

The first analysis wrapper 270 will be described referring to FIG. 24.

The first analysis wrapper 270 includes an include statement 271, a definition statement 272, a definition portion 273, a pre-event condition statement 274, an initialization statement 275, a loop statement 276, and a post-event condition statement 277.

The include statement 271 is a statement to include an inspection header 240.

The definition statement 272 is a statement to define an analysis step number.

The definition portion 273 is a definition portion of an inspection function step_judge_x.

The pre-event condition statement 274 is a statement defining a first pre-event condition that the input value of the first time to a first function x is equal to the input value of the second time and beyond, to the first function x.

The initialization statement 275 is a statement to initialize a first state variable state_x. More specifically, the initialization statement 275 is a statement which calls a first initialization function state_x_init. The initialization statement 275 is described as a statement executed prior to the loop statement 276.

The loop statement 276 is a statement to call the first function x repeatedly.

The post-event condition statement 277 is a statement defining the first post-event condition that the output value of the first time from the first function x is equal to the output value of the second time and beyond, from the first function x, and that the value of the first state variable of the first time of the first function x is equal to the value of the first state variable of the second time and beyond, of the first function x.

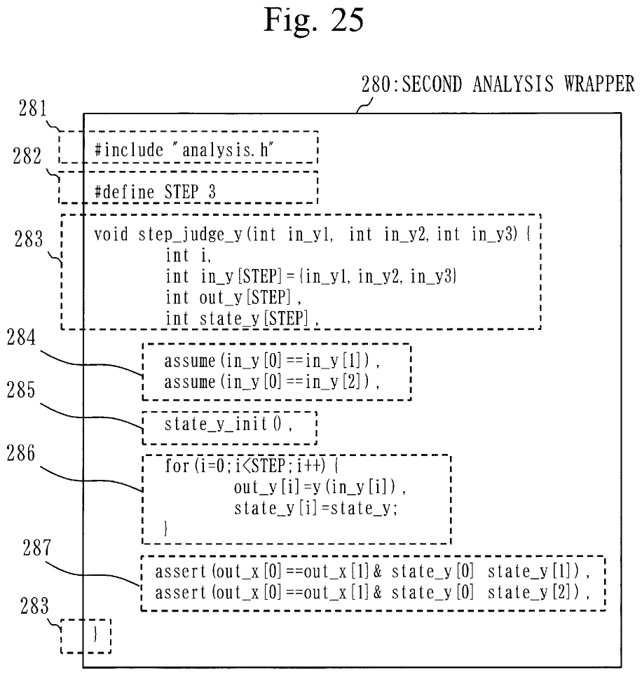

A second analysis wrapper 280 will be described referring to FIG. 25.

The second analysis wrapper 280 includes an include statement 281, a definition statement 282, a definition portion 283, a pre-event condition statement 284, an initialization statement 285, a loop statement 286, and a post-event condition statement 287.

The include statement 281 is a statement to include the inspection header 240.

The definition statement 282 is a statement to define an analysis step number.

The definition portion 283 is a definition portion of an inspection function step_judge_y.

The pre-event condition statement 284 is a statement defining the second pre-event condition that the input value of the first time to the second function y is equal to the input value of the second time and beyond, to the second function y.

The initialization statement 285 is a statement to initialize a second state variable state_y. More specifically, the initialization statement 285 is a statement that calls a second initialization function state_y_init. The initialization statement 285 is described as a statement executed prior to the loop statement 286.

The loop statement 286 is a statement to call a second function y repeatedly.

The post-event condition statement 287 is a statement defining a second post-event condition that the output value of the first time from the second function x is equal to the output value of the second time and beyond, from the second function y and that the value of the first time of the second state variable of the second function y is equal to the value of the second state variable of the second time and beyond, of the second function y.

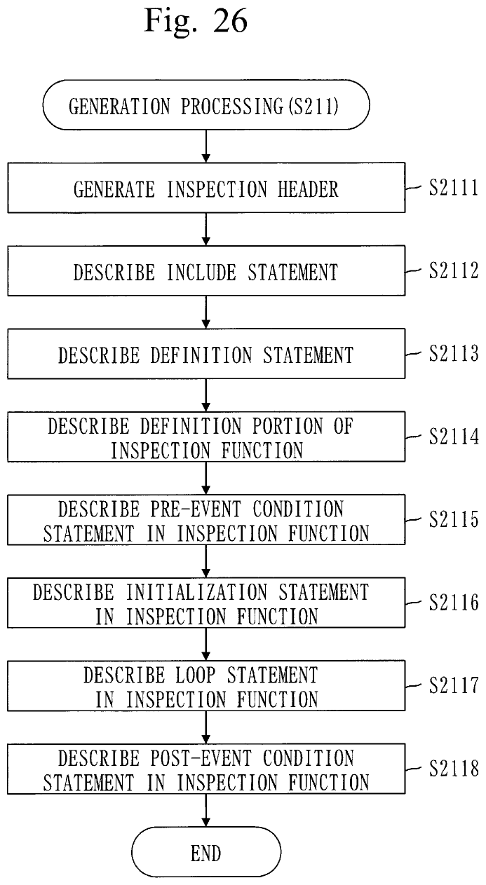

A procedure of generation processing (S211) will be described referring to FIG. 26.

In step S2111, a generation unit 110 generates the inspection header 240 (see FIG. 9).

The generation unit 110 generates the first analysis wrapper 270 (see FIG. 24) and the second analysis wrapper 280 (see FIG. 25) by step S2112 to step S2118.

In step S2112, the generation unit 110 describes the include statement 271 to the head of the first analysis wrapper 270, and describes the include statement 281 to the head of the second analysis wrapper 280.

In step S2113, the generation unit 110 describes the definition statement 272 under the include statement 271, and describes the definition statement 282 under the include statement 281.

In step S2114, the generation unit 110 describes the definition portion 273 of the inspection function step_judge_x in the first analysis wrapper 270.

More specifically, the generation unit 110 generates the definition portion 273 as follows, and describes the generated definition portion 273 under the definition statement 272.

First, the generation unit 110 describes a prototype of the inspection function step_judge_x. Note that “void step_judge_x ( ) { }” is a prototype of the inspection function step_judge_x.

Subsequently, the generation unit 110 generates input variables for the first function x by the same number as the analysis step number, and describes the generated input variables as arguments of the inspection function step_judge_x. Note that in_x1, in_x2, and in_x3 are input variables for the first function x.

Then, the generation unit 110 generates definition statements each defining an internal variable used in the inspection function step_judge_x in accordance with the format of a definition statement, and describes the generated definition statements in the inspection function step_judge_x. The format of the definition statement is determined in advance.

The first definition statement is a statement defining an internal variable i. The internal variable i is a variable used for controlling the loop number in the loop statement 276.

The second definition statement is a statement defining an internal variable in_x[ ]. The internal variable in_x[ ] is an array in which the value of the input variable for the first function x is assigned.

The third definition statement is a statement defining an internal variable out_x[ ]. The internal variable out_x[ ] is an array in which the output value from the first function x is assigned.

The fourth definition statement is a statement defining an internal variable state_x[ ]. The internal variable state_x[ ] is an array in which the value of the first state function is assigned.

Likewise, the generation unit 110 describes the definition portion 283 of an inspection function step_judge_y in the second analysis wrapper 280.

In step S2115, the generation unit 110 describes the pre-event condition statement 274 in the inspection function step_judge_x.

More specifically, the generation unit 110 generates a pre-event condition statement by a number less than the analysis step number by one in accordance with the format of a pre-event condition statement, and describes the generated pre-event condition statement under the four definition statements of the definition portion 273. The generated pre-event condition statement constitutes the pre-event condition statement 274. The format of the pre-event condition statement is determined in advance.

An m-th pre-event condition statement is a statement defining a pre-event condition that an input value of the first time to the first function x is equal to an input value of the (m+1) time to the first function x, where m is an integer of 1 or more and ((analysis step number)−1) or less.

Likewise, the generation unit 110 describes the pre-event condition statement 284 in the inspection function step_judge_y.

In step S2116, the generation unit 110 describes the initialization statement 275 in the inspection function step_judge_x, and describes the initialization statement 285 in the inspection function step_judge_y.

More specifically, the generation unit 110 generates the initialization statement 275 using the function name of the first initialization function state_x_init, and describes the initialization statement 275 under the pre-event condition statement 274. Furthermore, the generation unit 110 generates the initialization statement 285 using the function name of the second initialization function state_y_init, and describes the initialization statement 285 under the pre-event condition statement 284.

In step S2117, the generation unit 110 describes the loop statement 276 in the inspection function step_judge_x.

More specifically, the generation unit 110 describes a for statement stating a repetition condition that the value of the internal variable i is equal to the analysis step number or less, under the initialization statement 275. Then, the generation unit 110 generates a call statement in accordance with the format of a call statement, generates an assignment statement in accordance with the format of an assignment statement, and describes the call statement and the assignment statement in the for statement. The format of the call statement and the format of the assignment statement are determined in advance.

The call statement is a statement, in the i-th loop, for calling the first function x, by taking the value of an internal variable in_x[i] for the first function x, as an input value, and for assigning an output value from the first function x to an internal variable out_x[i] for the first function x.

The assignment statement is a statement, in the i-th loop, for assigning the value of the first state variable state_x to the internal variable state_x[i] for the first function x.

Likewise, the generation unit 110 describes the loop statement 286 in the inspection function step_judge_y.

In step 2118, the generation unit 110 describes the post-event condition statement 277 in the inspection function setp_judge_x.

More specifically, the generation unit 110 generates a post-event condition statement by a number less than the analysis step number by one in accordance with the format of a post-event condition statement, and describes the generated post-event condition statement under the loop statement 276. The generated post-event condition statement constitutes the post-event condition statement 277.

An m-th post-event condition statement is a statement defining a post-event condition that an output value of the first time from the first function x is equal to an output value of the (m+1) time from first function, x where m is an integer of 1 or more and equal to ((analysis step number)−1) or less.

Likewise, the generation unit 110 describes the post-event condition statement 287 in the inspection function step_judge_y.

Back to FIG. 23, step S212 will be described.

In step S212, the editing unit 120 edits the first program 210 and the second program 220 for the purpose of equivalence inspection.

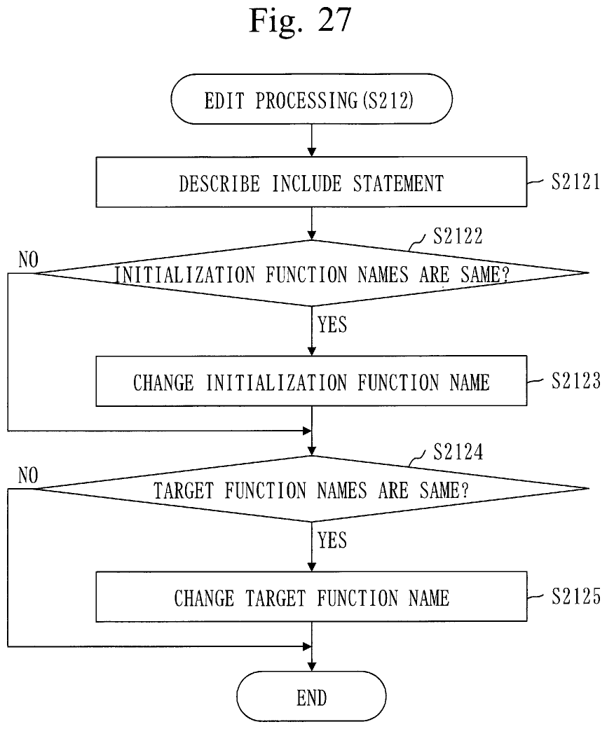

A procedure of edit processing (S212) will be described referring to FIG. 27.

Step S2121 is the same as step S121 in Embodiment 1 (see FIG. 14).

Step S2122 is the same as step S122 in Embodiment 1 (see FIG. 14).

Step S2123 is the same as step S123 in Embodiment 1 (see FIG. 14).

Step S2124 is the same as step S124 in Embodiment 1 (see FIG. 14).

Step S2125 is the same as step S125 in Embodiment 1 (see FIG. 14).

Back to FIG. 23, step S213 will be described.

In step S213, the analysis unit 140 conducts first equivalence inspection and second equivalence inspection.

First equivalence inspection is an equivalence inspection for the first function x. Equivalence inspection for the first function x is an inspection that is conducted for each calling time number where the first function x is called, for determining whether the first post-event condition is satisfied.

Second equivalence inspection is an equivalence inspection for the second function y. Equivalence inspection for the second function y is an inspection that is conducted for each calling time number where the second function y is called, for determining whether the second post-event condition is satisfied.

More specifically, the analysis unit 140 executes a model inspection tool using the first analysis wrapper 270. Hence, for each calling time number where the first function x is called, it is determined whether the first post-event condition is satisfied. Furthermore, the analysis unit 140 executes the model inspection tool using the second analysis wrapper 280. Hence, for each calling time number where the second function y is called, it is determined whether the second post-event condition is satisfied.

More specifically, the model inspection tool is executed as follows.

If the model inspection tool has a conversion function, the analysis unit 140, by taking the edited first program 210 and the first analysis wrapper 270 as input, executes the model inspection tool. Hence, the edited first program 210 and the first analysis wrapper 270 are converted into an inspection code, and the inspection code is executed. Then, an execution result of equivalence inspection for the first function x is outputted.

Furthermore, the inspection unit 130, by taking the edited second program 220 and the second analysis wrapper 280 as input, executes the model inspection tool. Hence, the edited second program 220 and the second analysis wrapper 280 are converted into an inspection code, and the inspection code is executed. Then, an execution result of equivalence inspection for the second function y is outputted.

If the model inspection tool does not have a conversion function, the analysis unit 140 converts the edited first program 210 and the first analysis wrapper 270 into an inspection tool. This conversion method is the same as the method by the model inspection tool having a conversion function. Then, the analysis unit 140, by taking the inspection code as input, executes the model execution tool. Hence, an execution result of equivalence inspection for the first function x is outputted.

Furthermore, the analysis unit 140 converts the edited second program 220 and the second analysis wrapper 280 into an inspection code. This conversion method is the same as the method by the model inspection tool having a conversion function. Then, the analysis unit 140, by taking the inspection code as input, executes the model inspection tool. Hence, an execution result of equivalence inspection for the second function y is outputted.

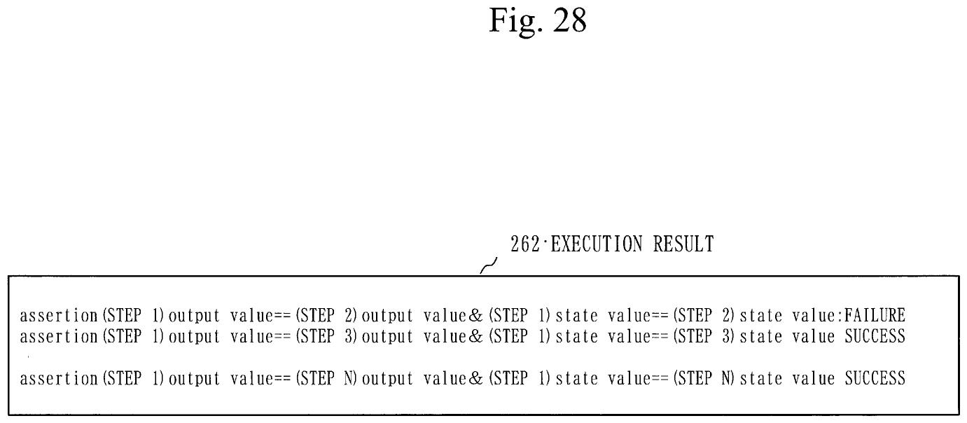

An execution result 262 will be described referring to FIG. 28.

The execution result 262 is an example of the execution result obtained by step S213.

(Step 1): The output value signifies an output value of the first time from the target function.

(Step m): The output value signifies an output value of the m-th time from the target function.

(Step l): The state value signifies a state value of the first time of the target function.

(Step m): The state value signifies a state value of the m-th time of the target function.

FAILURE signifies that the post-event condition is not satisfied.

SUCCESS signifies that the post-event condition is satisfied.

Back to FIG. 23, step S214 will be described.

In step S214, the analysis unit 140 obtains a first cyclic number based on the result of the first equivalence inspection, and obtains a second cyclic number based on the result of the second equivalence inspection.

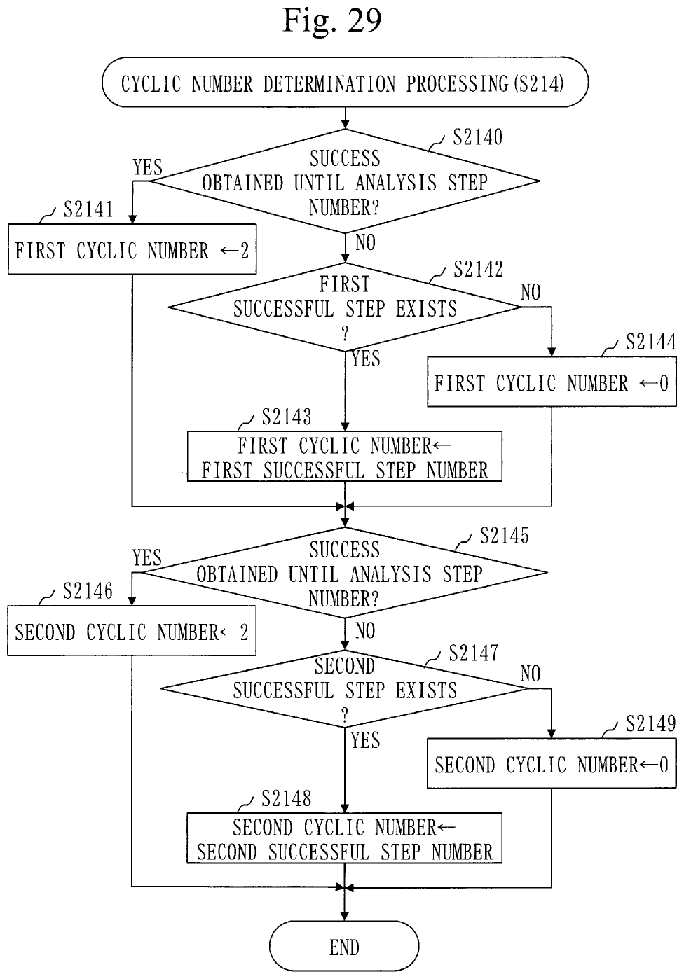

A procedure of cyclic number determination processing (step S214) will be described referring to FIG. 29.

In step S2140, the analysis unit 140 determines whether success has been obtained until the analysis step number by referring to the result of the first equivalence inspection. Success means that the first post-event condition is satisfied.

If success has been obtained until the analysis step number, the processing proceeds to step S2141.

If a non-successful analysis step exists, the processing proceeds to step S2142.

In step S2141, the analysis unit 140 updates the first cyclic number with 2.

After step S2141, the processing proceeds to step S2145.

In step S2142, the analysis unit 140 determines whether a first successful step exists by referring to the result of the first equivalence inspection. A first successful step is an analysis step where the first post-event condition is satisfied.

If a first successful step exists, the processing proceeds to step S2143.

If a first successful step does not exist, the processing proceeds to step S2144.

In step S2143, the analysis unit 140 updates the first cyclic number with the first successful step number. The first successful step number is the step number at the time of the first successful step.

After step S2143, the processing proceeds to step S2145.

In step S2144, the analysis unit 140 updates the first cyclic number with 0.

In step S2145, the analysis unit 140 determines whether success has been obtained until the analysis step number by referring to the result of the second equivalence inspection.

If success has been obtained until the analysis step number, the processing proceeds to step S2146.

If an unsuccessful analysis step exists, the processing proceeds to step 2147.

In step S2146, the analysis unit 140 updates the second cyclic number with 2.

After step S2146, the cyclic number determination processing (S214) ends.

In step S2147, the analysis unit 140 determines whether a second successful step exists by referring to the result of the second equivalence inspection. A second successful step is an analysis step where the second post-event condition is satisfied.

If a second successful step exists, the processing proceeds to step S2148.

If a second successful step does not exist, the processing proceeds to step S2149.

In step S2148, the analysis unit 140 updates the second cyclic number with the second successful step number. The second successful step number is the step number at the time of the second successful step.

After step S2148, the cyclic number determination processing (S214) ends.

In step S2149, the analysis unit 140 determines the second cyclic number as 0.

Back to FIG. 23, step S215 will be described.

In step S215, the analysis unit 140 determines the inspection step number based on the first cyclic number and the second cyclic number.

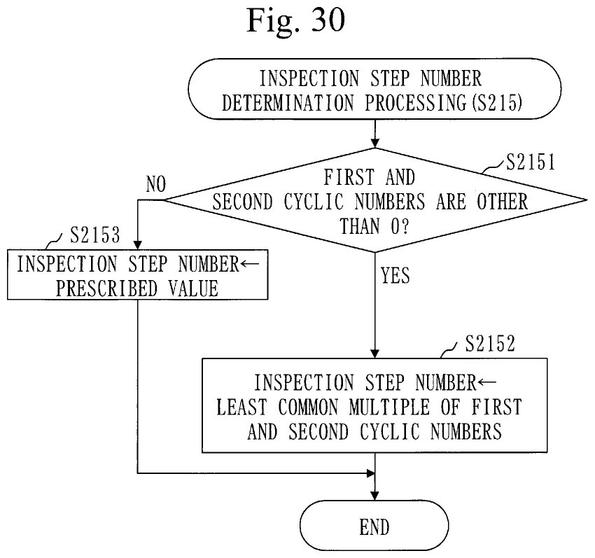

A procedure of inspection step number determination processing (S215) will be described referring to FIG. 30.

In step S2151, the analysis unit 140 determines whether both of the first cyclic number and the second cyclic number are other than 0.

If both of the first cyclic number and the second cyclic number are other than 0, the processing proceeds to step S2152.

If at least one of the first cyclic number and the second cyclic number is 0, the processing proceeds to step S2153.

In step S2152, the analysis unit 140 calculates the least common multiple of the first cyclic number and the second cyclic number.

Then, the analysis unit 140 updates the inspection step number with the least common multiple of the first cyclic number and the second cyclic number.

In step S2153, the analysis unit 140 updates the inspection step number with a prescribed value. A prescribed value is a predetermined value.

### Effect of Embodiment 2

An inspection step number corresponding to the cyclic number can be determined. By conducting equivalence inspection at the inspection step number corresponding to the cyclic number, whether functions are completely equivalent or not can be determined.

### Supplement to Embodiments

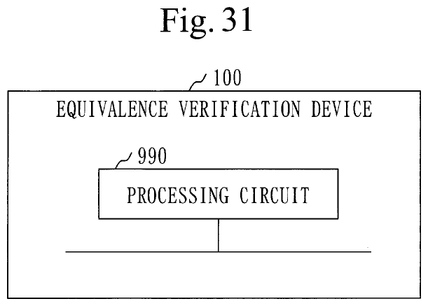

A hardware configuration of the equivalence verification device 100 will be described referring to FIG. 31.

The equivalence verification device 100 is provided with a processing circuitry 990.

The processing circuitry 990 is hardware that implements the generation unit 110, the editing unit 120, the inspection unit 130, and the analysis unit 140.

The processing circuitry 990 may be dedicated hardware, or the processor 901 that executes the program stored in the memory 902.

When the processing circuitry 990 is dedicated hardware, the processing circuitry 990 is, for example, a single circuit, a composite circuit, a programmed processor, a parallel-programmed processor, a logic IC, a GA, an ASIC, or an FPGA; or a combination of them.

Note that GA is an abbreviation for gate array, that ASIC is an abbreviation for application specific integrated circuit, and that FPGA is an abbreviation for field programmable gate array.

The equivalence verification device 100 may be provided with a plurality of processing circuits that replace the processing circuitry 990. The plurality of processing circuits share the role of the processing circuitry 990.

Regarding the function of the equivalence verification device 100, part of the function may be implemented by dedicated hardware, and the remaining part may be implemented by software or firmware.

In this manner, the processing circuitry 990 can be implemented by the hardware, the software, and the firmware; or a combination of them.

An embodiment exemplifies a preferred embodiment and is not intended to limit the technical scope of the present invention. An embodiment may be practiced partly, or may be practiced by combination with another embodiment. The procedures that are described using the flowcharts and so on may be changed appropriately.

### REFERENCE SIGNS LIST

100: equivalence verification device; 110: generation unit; 120: editing unit; 130: inspection unit; 140: analysis unit; 191: storage unit; 210: first program; 211: include statement; 220: second program; 221: include statement; 230: target information; 231: target information; 240: inspection header; 241: declaration statement; 242: declaration statement; 250: inspection wrapper; 251: include statement; 252: definition statement; 253: definition portion; 254: pre-event condition statement; 255: initialization statement; 256: loop statement; 257: post-event condition statement; 260: execution result; 261: execution result; 262: execution result; 270: first analysis wrapper; 271: include statement; 272: definition statement; 273: definition portion; 274: pre-event condition statement; 275: initialization statement; 276: loop statement; 277: post-event condition statement; 280: second analysis wrapper; 281: include statement; 282: definition statement; 283: definition portion; 284: pre-event condition statement; 285: initialization statement; 286: loop statement; 287: post-event condition statement; 901: processor; 902: memory; 903: auxiliary storage device; 990: processing circuitry

1. An equivalence verification device comprising processing circuitry to inspect equivalence of a first function and a second function by conducting equivalence inspection using an inspection wrapper being a program code including a loop statement for repeatedly calling the first function and the second function,
wherein the first function is included in a first program, is executed a plurality of times in the first program, uses a first state variable whose value changes each time the first function is executed, and outputs a value corresponding to the value of the first state variable, and
wherein the second function is included in a second program, is executed a plurality of times in the second program, uses a second state variable whose value changes each time the second function is executed, and outputs a value corresponding to the value of the second state variable.

2. The equivalence verification device according to claim 1,
wherein the processing circuitry determines the equivalence of the first function and the second function for each calling time number where the first function and the function are called.

3. The equivalence verification device according to claim 2,
wherein the processing circuitry specifies a calling time number of when the first function and the second function are non-equivalent based on a determination result for each calling time number where the first function and the second function are called.

4. (canceled)

5. The equivalence verification device according to claim 1, wherein the processing circuitry generates the inspection wrapper by describing the loop statement.

6. The equivalence verification device according to claim 5,
wherein the processing circuitry further describes an initialization statement for initializing the first state variable and the second state variable, in the inspection wrapper as a statement executed prior to the loop statement.

7. The equivalence verification device according to claim 6,
wherein the initialization statement is a statement that calls a first initialization function for initializing the first state variable and a second initialization function for initializing the second state variable.

8. The equivalence verification device according to claim 7,
wherein the processing circuitry further describes an include statement to include an inspection header including a declaration statement for referring to the first initialization function and the second initialization function, in the inspection wrapper.

9. The equivalence verification device according to claim 5,
wherein the processing circuitry further describes a pre-event condition statement and a post-event condition statement in the inspection wrapper, the pre-event condition statement defining a pre-event condition that an input value to the first function and an input value to the second function are equal, the post-event condition statement defining a post-event condition that an output value from the first function and an output value from the second function are equal.

10. The equivalence verification device according to claim 5,
wherein the processing circuitry further describes a definition statement defining a number of times the first function and the second function are called, in the inspection wrapper.

11. The equivalence verification device according to claim 10,
wherein the processing circuitry
obtains a first cyclic number and a second cyclic number, the first cyclic number being a calling time number of the first function of when the value of the first state variable returns to an initial value, the second cyclic number being a calling time number of the second function of when the value of a second state variable returns to an initial value, and determines a number of times the first function and the second function are called by the inspection wrapper, based on the first cyclic number and the second cyclic number, and
describes a statement defining the determined number of times in the inspection wrapper as the definition statement.

12. The equivalence verification device according to claim 11,
wherein the processing circuitry obtains the first cyclic number by conducting equivalence inspection using a first analysis wrapper being a program code including a first loop statement for repeatedly calling the first function, and obtains the second cyclic number by conducting equivalence inspection using a second analysis wrapper being a program code including a second loop statement for repeatedly calling the second function.

13. A non-transitory computer readable medium storing an equivalence verification program that causes a computer to execute inspection processing of inspecting equivalence of a first function and a second function by conducting equivalence inspection using an inspection wrapper being a program code including a loop statement for repeatedly calling the first function and the second function,
wherein the first function is included in a first program, is executed a plurality of times in the first program, uses a first state variable whose value changes each time the first function is executed, and outputs a value corresponding to the value of the first state variable, and
wherein the second function is included in a second program, is executed a plurality of times in the second program, uses a second state variable whose value changes each time the second function is executed, and outputs a value corresponding to the value of the second state variable.
